(19) United States
(12) Patent Application Publication
(10) Pub. No.: US 2024/0151247 A1
(43) Pub. Date: May 9, 2024

(54) HYDRAULIC SYSTEM

(71) Applicant: OKUMA Corporation, Niwa-gun (JP)

(72) Inventor: Shoichi MORIMURA, Niwa-gun (JP)

(21) Appl. No.: 18/502,292

(22) Filed: Nov. 6, 2023

(30) Foreign Application Priority Data
Nov. 7, 2022 (JP) 2022-178206

(51) Int. Cl. F15B 9/03; F15B 9/09

(52) U.S. Cl. CPC F15B 9/03; F15B 9/09

(57) ABSTRACT

A hydraulic system includes: a first hydraulic cylinder including a first volume chamber and a second volume chamber; a second hydraulic cylinder including a third volume chamber and a fourth volume chamber a first connection pipe that allows the first volume chamber and the third volume chamber to communicate with each other; a second connection pipe that allows the second volume chamber and the fourth volume chamber to communicate with each other; and a correction mechanism that corrects a position of the first piston by causing the first piston to advance or retreat in a state where the second piston is stationary, in which the correction mechanism includes a brake that regulates a movement of the second piston and, a bypass pipe that allows the first connection pipe and the second connection pipe to communicate with each other; and a valve that opens and closes the bypass pipe.

### CROSS REFERENCE TO RELATED APPLICATION

The present invention claims priority under 35 U.S.C. § 119 to Japanese Patent Application No. 2022-178206 filed on Nov. 7, 2022, the entire contents of which being incorporated herein by reference.

### TECHNICAL FIELD

The present specification discloses a hydraulic system that transmits at least one of a position and a force by using a hydraulic pressure.

### BACKGROUND

Conventionally, there has been widely known, as an actuator, a hydraulic system that transmits at least one of a position and a force using a hydraulic pressure. As such a hydraulic system, there has been widely known a system including two hydraulic cylinders and transmitting a movement of one hydraulic cylinder to the other hydraulic cylinder.

For example, Patent Document 1 discloses a hydraulic system in which a volume chamber of a master-side cylinder (hereinafter referred to as a “first hydraulic cylinder”) communicates with a volume chamber of a slave-side cylinder (hereinafter referred to as a “second hydraulic cylinder”) through a tube. In this case, a linear motion mechanism is connected to a piston rod of the first hydraulic cylinder. As the first hydraulic cylinder moves, hydraulic oil is transmitted and received between the first hydraulic cylinder and the second hydraulic cylinder via the tube. Accordingly, the movement of the first hydraulic cylinder is transmitted to the second hydraulic cylinder.

### CITATION LIST

### Patent Literature

Patent Document 1: JP H10-325401 A

However, in a hydraulic system in which hydraulic oil is transmitted and received between two hydraulic cylinders as in Patent Document 1, there is a possibility that the movable range of the second hydraulic cylinder cannot be appropriately maintained due to leakage of the hydraulic oil.

That is, in the configuration of Patent Document 1, as a piston of the first hydraulic cylinder (hereinafter referred to as a “first piston”) retreats, a piston of the second hydraulic cylinder (hereinafter referred to as a “second piston”) advances. In other words, when the first piston reaches a proximal end of the cylinder tube and cannot retreat further, further advancement of the second piston is also regulated. Therefore, usually, the position of the first piston with respect to the position of the second piston is adjusted in advance so that the second piston can reach the maximum advancing position before the first piston reaches the proximal end of the cylinder tube.

However, when the hydraulic oil leaks as the piston moves, the position of the first piston is deviated with respect to the position of the second piston. Then, if deviations accumulate, the second piston may be unable to move to the maximum advancing position, because the first piston reaches the proximal end of the cylinder tube before the second piston reaches the maximum advancing position. That is, in the conventional art, there is a possibility that the movable range of the second hydraulic cylinder cannot be appropriately maintained.

Therefore, the present specification discloses a hydraulic system capable of appropriately maintaining a movable range of a second hydraulic cylinder with a simple configuration.

### SUMMARY

A hydraulic system disclosed in the present specification includes: a first hydraulic cylinder including a first piston, and a first volume chamber and a second volume chamber whose volumes change as the first piston advances or retreats; a second hydraulic cylinder including a second piston driven by the first piston, and a third volume chamber and a fourth volume chamber whose volumes change as the second piston advances or retreats; hydraulic oil filled in the first hydraulic cylinder and the second hydraulic cylinder; a transmission mechanism including a first connection pipe that allows the first volume chamber and the third volume chamber to communicate with each other and a second connection pipe that allows the second volume chamber and the fourth volume chamber to communicate with each other, the transmission mechanism transmitting a movement of the first piston to the second piston via the hydraulic oil; and a correction mechanism that corrects a position of the first piston by causing the first piston to advance or retreat in a state where the second piston is stationary; in which the correction mechanism includes: a brake that regulates a movement of the second piston; a bypass pipe that allows the first connection pipe and the second connection pipe to communicate with each other; and a valve that opens and closes the bypass pipe.

The hydraulic system may further include: a first position sensor that detects a position of the first piston as a first detection position; a second position sensor that detects a position of the second piston as a second detection position; and a controller that determines whether it is necessary to correct the position of the first piston based on a comparison between the first detection position and the second detection position.

The first position sensor may be a contact or non-contact limit switch that outputs a signal when the first piston reaches a prescribed driving-side reference position, and the controller may specify a positional deviation amount of the first piston based on a second detection position when the first piston reaches the driving-side reference position.

The controller may correct the position of the first piston or output an alarm at a timing when a positional deviation amount of the first piston exceeds a prescribed reference deviation amount.

The controller may correct the position of the first piston or output an alarm at a timing when at least one of an operation time, the number of times of operation, and an operation distance of the first hydraulic cylinder or the second hydraulic cylinder exceeds a prescribed reference value.

The second hydraulic cylinder may be incorporated in a movable portion of a host actuator, and the controller may correct the position of the first piston or output an alarm at a timing when an operation command stops with respect to the movable portion.

The correction mechanism may further include a throttle provided in the bypass pipe.

The first hydraulic cylinder may have a larger volume than the second hydraulic cylinder.

According to the hydraulic system disclosed in the present specification, since the first piston can advance or retreat in a state where the second piston is stationary, the position of the first piston can be corrected. As a result, the movable range of the second hydraulic cylinder can be appropriately maintained even when leakage of the hydraulic oil occurs.

### BRIEF DESCRIPTION OF DRAWINGS

FIG. 1 is a schematic diagram illustrating the configuration of a hydraulic system.

FIG. 2 is a schematic diagram illustrating a configuration of a brake.

FIG. 3A is a diagram for explaining a movable range of a second piston.

FIG. 3B is a diagram for explaining the movable range of the second piston when a positional deviation of a first piston occurs.

FIG. 4 is a schematic diagram illustrating how the position of the first piston is corrected.

FIG. 5 is a flowchart illustrating a flow of a position correction of the first piston.

FIG. 6 is a flowchart illustrating a flow of determining a timing at which the position correction of the first piston is executed.

FIG. 7 is a diagram illustrating another example of a hydraulic system.

FIG. 8 is a diagram illustrating another example of a hydraulic system.

### DESCRIPTION OF EMBODIMENT

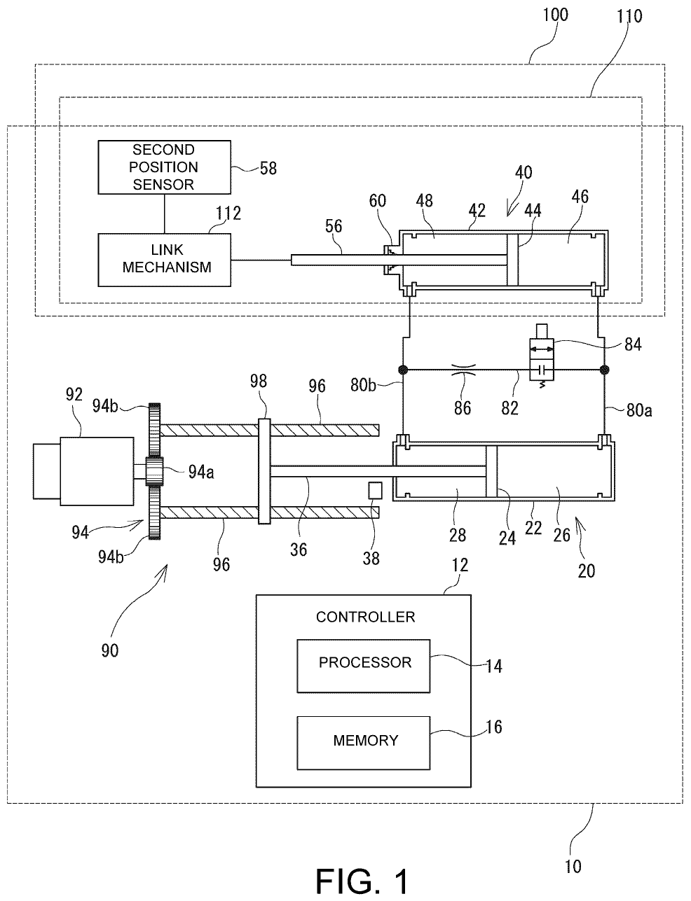

Hereinafter, a configuration of a hydraulic system 10 will be described with reference to the drawings. FIG. 1 is a schematic diagram illustrating the configuration of the hydraulic system 10. As illustrated in FIG. 1, the hydraulic system 10 includes a first hydraulic cylinder 20, a second hydraulic cylinder 40, a linear motion mechanism 90, a plurality of pipes 80a, 80b, and 82, and a controller 12. Among them, the second hydraulic cylinder 40 is incorporated in, for example, a movable portion 110 of a host actuator 100. The host actuator 100 is a device that is moved by power output from the second hydraulic cylinder 40, and is, for example, an articulated arm type robot. In this case, the movable portion 110 is a joint portion or a hand portion of the robot.

The first hydraulic cylinder 20 is a hydraulic cylinder driven by the linear motion mechanism 90. The first hydraulic cylinder 20 includes a first cylinder tube 22, and a first piston 24 that advances or retreats inside the first cylinder tube 22. A first piston rod 36 is connected to the first piston 24. The first piston rod 36 extends from the first piston 24 to the outside of the first cylinder tube 22. Hereinafter, as viewed from the first piston 24, the first piston rod 36 side will be referred to as an “advancing direction” or a “rod side”, and the opposite side will be referred to as a “retreating direction” or a “head side”.

The first piston 24 divides the inside of the first cylinder tube 22 into a first volume chamber 26 and a second volume chamber 28. The first volume chamber 26 is located on the head side with respect to the first piston 24, and the second volume chamber 28 is located on the rod side with respect to the first piston 24. The first volume chamber 26 communicates with a third volume chamber 46, which will be described later, via the first connection pipe 80a. The second volume chamber 28 communicates with a fourth volume chamber 48, which will be described later, via the second connection pipe 80b.

A first position sensor 38 detects a position of the first piston 24 and outputs the detected position of the first piston 24 as a first detection position. Here, the first position sensor 38 may be a sensor that accurately detects a position of the first piston 24, or may be a simple sensor that detects an approximate position of the first piston. For example, the first position sensor 38 may be a limit switch that outputs a signal when the first piston 24 reaches a prescribed reference position. In this case, the limit switch may be either a contact type or a non-contact type.

The second hydraulic cylinder 40 includes a second cylinder tube 42, and a second piston 44 that advances or retreats inside the second cylinder tube 42. In the present example, the second hydraulic cylinder 40 has a smaller volume than the first hydraulic cylinder 20. A second piston rod 56 is connected to the second piston 44. The second piston rod 56 protrudes to the outside of the second cylinder tube 42. A link mechanism 112 is connected to the second cylinder tube 42. As the link mechanism 112 moves, the movable portion 110 of the host actuator 100 moves.

A second position sensor 58 detects a position of the second piston 44 directly or indirectly via the link mechanism 112, and outputs the detected position of the second piston 44 as a second detection position. Here, the second piston 44 or the link mechanism 112 is an object of which a position is to be controlled, and thus, a sensor with higher accuracy than the first position sensor 38 is used as the second position sensor 58.

The second piston 44 divides the inside of the second cylinder tube 42 into the third volume chamber 46 and the fourth volume chamber 48. The third volume chamber 46 is located on the head side with respect to the second piston 44, and the fourth volume chamber 48 is located on the rod side with respect to the second piston 44. As described above, the third volume chamber 46 communicates with the first volume chamber 26 via the first connection pipe 80a. In addition, the fourth volume chamber 48 communicates with the second volume chamber 28 via the second connection pipe 80b.

The first cylinder tube 22 and the second cylinder tube 42 are filled therein with hydraulic oil that is an incompressible fluid. Therefore, when the volume of the first volume chamber 26 decreases as the first piston 24 retreats, the hydraulic oil in the first volume chamber 26 flows into the third volume chamber 46 via the first connection pipe 80a, and the second piston 44 moves in the advancing direction. When the volume of the second volume chamber 28 decreases as the first piston 24 advances, the hydraulic oil in the second volume chamber 28 flows into the fourth volume chamber 48 via the second connection pipe 80b, and the second piston 44 moves in the retreating direction. That is, the first connection pipe 80a and the second connection pipe 80b function as a transmission mechanism that transmits the movement of the first piston 24 to the second piston 44 via the hydraulic oil.

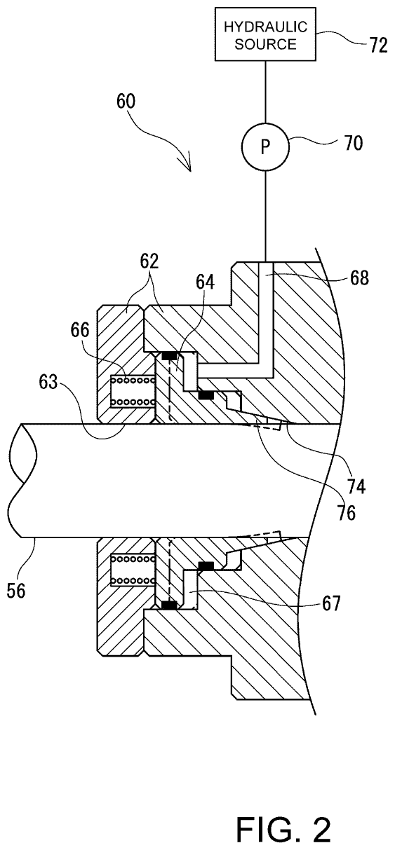

The second hydraulic cylinder 40 further includes a brake 60 that regulates the movement of the second piston 44. The brake 60 is a friction brake that is pressed against the second piston rod 56 such that the movement of the second piston rod 56 is regulated by frictional force. FIG. 2 is a schematic diagram illustrating a configuration of the brake 60.

As illustrated in FIG. 2, the brake 60 includes a fixed body 62 fixed to the second cylinder tube 42, and a movable body 64 that moves with respect to the fixed body 62. A through hole 63 through which the second piston rod 56 is inserted is formed in the fixed body 62. A tapered surface 74 is formed in a partial portion of an inner circumferential surface of the through hole 63 in such a manner that the diameter of the through hole 63 decreases toward the head side. The movable body 64 has a wedge portion 76 along the tapered surface 74.

The movable body 64 is biased toward the head side by a spring 66. A sealed space 67 is formed between the movable body 64 and the fixed body 62. A hydraulic pressure supply path 68 connected to the sealed space 67 is formed in the fixed body 62. When the hydraulic oil is supplied to the sealed space 67 from a hydraulic source 72 by a brake pump 70, the movable body 64 moves toward the rod side against the biasing force of the spring 66. On the other hand, when the hydraulic oil flows out of the sealed space 67, the movable body 64 moves toward the head side by the biasing force of the spring 66. As a result, the wedge portion 76 enters a gap between the tapered surface 74 and the second piston rod 56. As a result, large friction is generated between the wedge portion 76 and the second piston rod 56, and the movement of the second piston rod 56 and the second piston 44 is regulated.

The configuration of the brake 60 described here is an example, and the brake 60 may have another configuration so long as it is capable of regulating the movement of the second piston 44. Therefore, for example, the brake 60 may be provided in the movable portion 110, which is movable by power output from the second hydraulic cylinder 40, rather than in the second hydraulic cylinder 40. For example, in a case where the joint of the robot is moved by the power output from the second hydraulic cylinder 40, the brake 60 may be a brake that locks the rotation of the joint of the robot. The brake 60 is not limited to a friction brake and may be a brake of another form.

Next, the linear motion mechanism 90 will be described. The linear motion mechanism 90 causes the first piston 24 to advance or retreat straight. As illustrated in FIG. 1, the linear motion mechanism 90 includes a servomotor 92, a gear unit 94, and ball screws 96. The gear unit 94 includes a main gear 94a attached to an output shaft of the servomotor 92 and a pair of sub gears 94b engaged with the main gear 94a. The pair of sub gears 94b are disposed at 1800 symmetrical positions with the main gear 94a interposed therebetween, and rotate in the same direction as the main gear 94a rotates. The ball screws 96 are fixed to the respective sub gears 94b, and the ball screws 96 also rotate as the sub gears 94b rotate. A moving block 98 is fastened to the pair of ball screws 96 in a screwed manner. The first piston rod 36 is fixed to the moving block 98. Therefore, when the pair of ball screws 96 rotates as the servomotor 92 drives, the moving block 98, and furthermore, the first piston rod 36 and the first piston 24, advance or retreat straight.

The linear motion mechanism 90 described here is an example. The linear motion mechanism 90 may have another configuration so long as it is capable of causing the first piston 24 to advance or retreat straight. For example, the linear motion mechanism 90 may be a mechanism formed by combining a motor and a timing belt, or may be a mechanism having a linear motor.

As illustrated in FIG. 1, the hydraulic system 10 in the present example includes the bypass pipe 82. The bypass pipe 82 allows the first connection pipe 80a and the second connection pipe 80b to communicate with each other. The bypass pipe 82 is provided with a valve 84 and a throttle 86. The configuration of the valve 84 is not limited so long as it is capable of opening and closing the bypass pipe 82. Therefore, the valve 84 may be, for example, a solenoid valve that can be opened or closed according to an electric signal, or a valve that is opened or closed by a manual operation of an operator. When a leakless valve that does not cause leakage of the hydraulic oil is used as the valve 84, the number of times the position of the first piston 24 is corrected, which will be described later, can be reduced. The valve 84 functions as a correction mechanism that corrects a positional deviation of the first piston 24 together with the bypass pipe 82 and the brake 60. This will be described later.

The controller 12 controls the operation of the hydraulic system 10. The controller 12 is physically a computer including a processor 14 and a memory 16. The “computer” also includes a microcontroller in which a computer system is incorporated into one integrated circuit. In addition, the controller 12 is not limited to a single computer, and may be configured by combining a plurality of computers physically separated from each other. In addition, the controller 12 may be a computer provided exclusively for the hydraulic system 10 or a computer provided for another control target. Therefore, for example, a computer provided to control the operation of the host actuator 100 may be used as the controller 12 of the hydraulic system 10.

The controller 12 drives the hydraulic system 10 in accordance with an operation command from the host actuator 100. Specifically, when the second piston rod 56 needs to advance, the controller 12 drives the servomotor 92 to move the first piston 24 in the retreating direction. When the second piston rod 56 needs to retreat, the controller 12 drives the servomotor 92 to move the first piston 24 in the advancing direction. At this time, the controller 12 only needs to monitor the positions of the second piston 44 and the link mechanism 112, and does not need to monitor the position of the first piston 24. However, in order to correct a positional deviation of the first piston 24, which will be described later, a position of the first piston 24 and a deviation amount DE of the first piston 24 are periodically acquired.

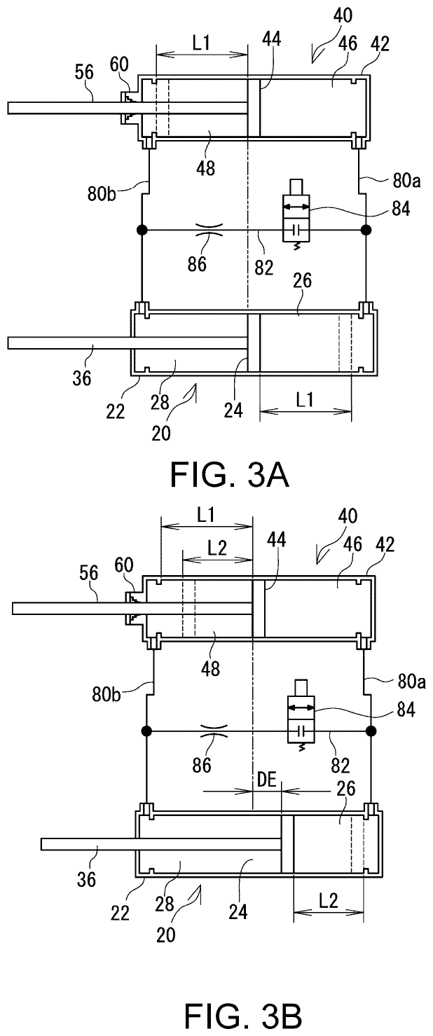

Next, the correction of the position of the first piston 24 will be described. First, the reason why such a position correction is necessary will be described with reference to FIG. 3A and FIG. 3B. In the present example, as stated above, the second piston 44 is moved by sending the hydraulic oil flowing out of the first hydraulic cylinder 20 to the second hydraulic cylinder 40 as the first piston 24 advances or retreats.

As the pistons 24 and 44 are moved and the volumes of the volume chambers 26, 28, 46, and 48 are changed, a large pressure acts on the hydraulic oil, and an internal leakage and an external leakage of the hydraulic oil may occur. In the internal leakage, the hydraulic oil passes through the seal between the pistons 24 and 44 and the cylinder tubes 22 and 42, and moves in the cylinder tubes 22 and 42. In the external leakage, the hydraulic oil passes through the seal between the piston rods 36 and 56 and the cylinder tubes 22 and 42, and leaks to the outside of the cylinder tubes 22 and 42.

When the leakage of the hydraulic oil, particularly the internal leakage, occurs in the first hydraulic cylinder 20, the first piston 24 deviates from an originally intended position. Normally, even if the position of the first piston 24 is displaced, there is no problem so long as the second piston 44 and the link mechanism 112 can be appropriately positioned. However, if such positional deviations of the first piston 24 accumulate and the positional deviation amount DE becomes large, the second piston 44 may not be appropriately positioned.

For example, it is assumed that, in the hydraulic system 10, the first cylinder tube 22 has the same cross-sectional area as the second cylinder tube 42, such that a movement amount of the first piston 24 is the same as a movement amount of the second piston 44.

As illustrated in FIG. 3A, it is assumed that when the second piston 44 is away from the rod-side end by a distance L1, the first piston 24 is away from the head-side end by the distance L1 or more. In this case, the first piston 24 can cause the second piston 44 to advance to the rod-side end by moving toward the head side.

On the other hand, it is assumed that by repeating the reciprocation of the first piston 24, leakages of the hydraulic oil and positional deviations of the first piston 24 accumulate, and the state is changed from the state of FIG. 3A to the state of FIG. 3B. In FIG. 3B, when the second piston 44 is away from the rod-side end by the distance L1, the first piston 24 is away from the head-side end only by a distance L2 (L2<L1). In this case, even though the first piston 24 is moved to the head-side end, the second piston 44 cannot be moved to the rod-side end. As a result, the second piston 44 cannot be appropriately positioned in the state of FIG. 3B in which the leakages of the hydraulic oil and the positional deviations of the first piston 24 accumulate.

Such a problem can be solved to some extent by making the volume of the first hydraulic cylinder 20 sufficiently larger than the volume of the second hydraulic cylinder 40. For example, the second piston 44 can be appropriately positioned by increasing the volume of the first hydraulic cylinder 20, in a state where the positional deviations of the first piston 24 have occurred in the example of FIG. 3B, so that the distance from the first piston 24 to the head-side end becomes L1 or more. However, even if the first hydraulic cylinder 20 is enlarged, if positional deviations of the first piston 24 further accumulate, a situation in which the first piston 24 cannot be appropriately positioned eventually occurs. In addition, when the size of the first hydraulic cylinder 20 is increased, other problems arise in that the size of the entire hydraulic system 10 increases and the cost increases.

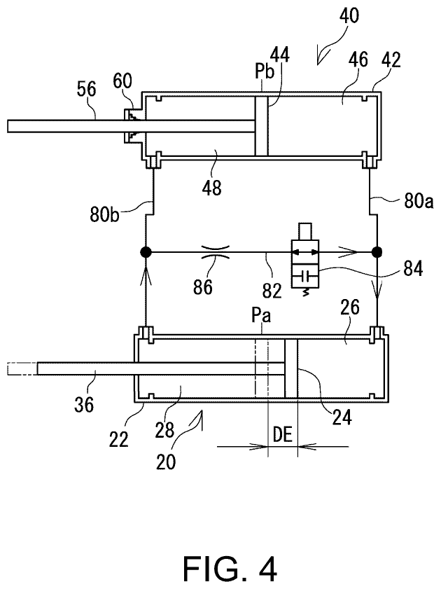

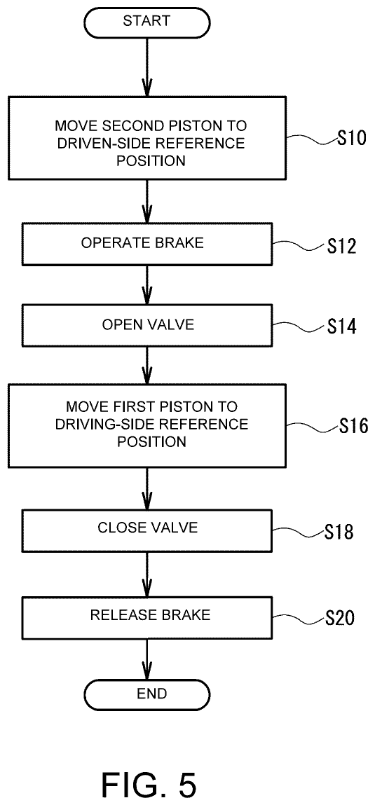

Therefore, in the present example, the bypass pipe 82 and the valve 84 are provided to correct the position of the first piston. This will be described with reference to FIGS. 4 and 5. FIG. 4 is a schematic diagram illustrating how the position of the first piston 24 is corrected. FIG. 5 is a flowchart illustrating a flow of a position correction of the first piston 24.

When the position of the first piston 24 needs to be corrected, the controller 12 drives the linear motion mechanism 90 to move the second piston 44 to a prescribed driven-side reference position Pb (S10). At this time, the valve 84 is closed as illustrated in FIG. 1.

Here, the driven-side reference position Pb is not particularly limited so long as it is within the movable range of the second piston 44. Therefore, the driven-side reference position Pb may be an end of the second cylinder tube 42 or a center position of the second cylinder tube 42. In the present example, the center position of the second cylinder tube 42 is set as the driven-side reference position Pb. If the driven-side reference position Pb is set to the center position of the second cylinder tube 42, the second piston 44 can be reliably moved to the driven-side reference position Pb even when the positional deviation amount DE of the first piston 24 is large.

When the second piston 44 moves to the driven-side reference position Pb, the controller 12 stops the linear motion mechanism 90 and then operates the brake 60 (S12). As a result, the second piston 44 is fixed at the driven-side reference position Pb.

Subsequently, the controller 12 opens the valve 84 as illustrated in FIG. 4 (S14). Thereafter, the controller 12 drives the linear motion mechanism 90 to move the first piston 24 to a driving-side reference position Pa (S16). Here, the driving-side reference position Pa is a position corresponding to the driven-side reference position Pb. Therefore, when the first piston 24 is moved to the driving-side reference position Pa in an ideal state where there is no positional deviation of the first piston 24, the second piston 44 moves to the driven-side reference position Pb.

When the first piston 24 is moved in a state where the brake 60 is operated and the valve 84 is opened, hydraulic oil is transmitted and received between the first volume chamber 26 and the second volume chamber 28. In the example of FIG. 4, when the first piston 24 is moved from a position indicated by a solid line to a position indicated by a broken line, the hydraulic oil in the second volume chamber 28 flows into the first volume chamber 26 through the bypass pipe 82. As a result, an internal leakage in the first hydraulic cylinder 20 and a positional deviation of the first piston 24 are eliminated.

Since the first volume chamber 26 and the second volume chamber 28 have different volumes, when the first piston 24 is moved in step S16, the compression rate of the hydraulic oil changes, and the internal pressures of the volume chambers 26 and 28 change. The change in internal pressure is affected by the amount of air mixed in the hydraulic oil, the softness of the pipes 80a, 80b, and 82, and the like. However, since the initial position before the positional deviation occurs should have been a reasonable pressure, there is no problem even if the positional deviation is corrected to the original position.

When the valve 84 is opened, the hydraulic oil is also transmitted and received between the third volume chamber 46 and the fourth volume chamber 48 so that the third volume chamber 46 and the fourth volume chamber 48 of the second hydraulic cylinder 40 have the same pressure. At this time, in order to avoid a sudden pressure change, in the present example, the throttle 86 is provided in the bypass pipe 82 to prevent a sudden movement of the hydraulic oil.

When the first piston 24 moves to the driving-side reference position Pa, the controller 12 stops the linear motion mechanism 90, and then closes the valve 84 and releases the brake 60 (S18 and S20). When the brake 60 is released, the position correction of the first piston 24 ends.

As is apparent from the above description, according to the present example, the positional deviation of the first piston 24 can be corrected. As a result, even when leakages of the hydraulic oil accumulate, influence thereof can be eliminated, and the second piston 44 can be appropriately positioned.

In the example of FIG. 5, the controller 12 corrects the position of the first piston 24. However, the operator may manually perform some of the above-described flow. For example, when determining that a position correction is necessary, the controller 12 may output an alarm for prompting the operator to execute the position correction. In this case, the operator may manually operate at least one of the linear motion mechanism 90, the brake 60, and the valve 84 as necessary.

Next, a timing at which the position correction of the first piston 24 is executed will be described. As described above, if the volume of the first hydraulic cylinder 20 is larger than the volume of the second hydraulic cylinder 40, the positional deviation amount DE can be allowed to some extent. Therefore, the allowable positional deviation amount may be stored in advance as a reference deviation amount DEst. Then, when the actually-occurring deviation amount DE is greater than or equal to the reference deviation amount DEst, the controller 12 may execute the positional deviation correction illustrated in FIG. 5 or output an alarm. In this case, the controller 12 monitors the positional deviation amount DE of the first piston 24 during a period in which the hydraulic system 10 is driven. For example, the controller 12 acquires a position of the second piston 44 as the second detection position whenever the first piston 24 reaches the driving-side reference position Pa during the period in which the hydraulic system 10 is driven. The controller 12 calculates a difference value between the obtained second detection position and the driven-side reference position Pb as the positional deviation amount DE. When the calculated positional deviation amount DE is greater than or equal to the prescribed reference deviation amount DEst, a position correction of the first piston 24 may be executed or an alarm may be output.

In another aspect, the controller 12 may execute a position correction of the first piston 24 or output an alarm at a timing when at least one of an operation time, the number of times of operation, and an operation distance of the first hydraulic cylinder 20 or the second hydraulic cylinder 40 exceeds a prescribed reference value.

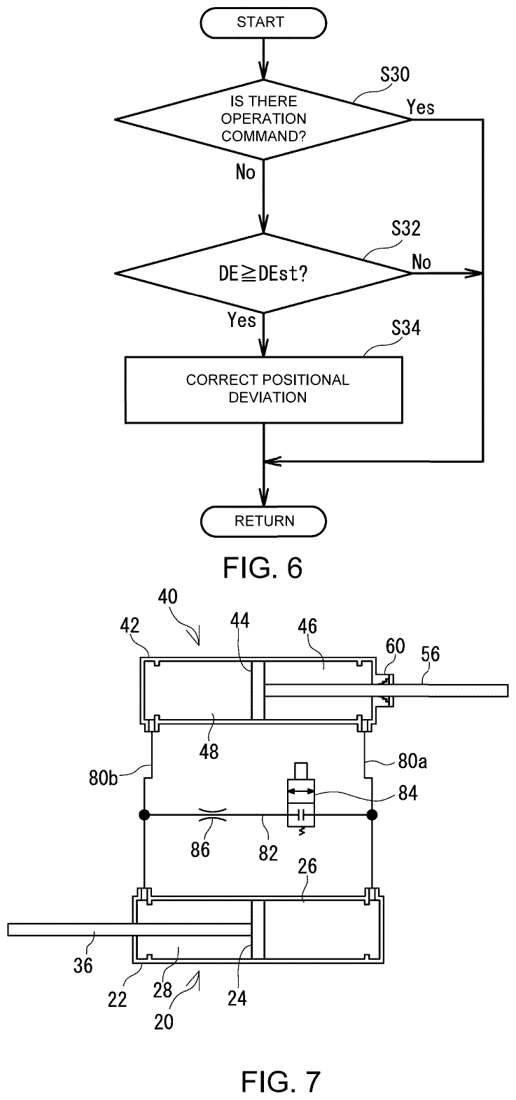

In another aspect, the controller 12 may execute a position correction of the first piston 24 or output an alarm at a timing when an operation command stops with respect to the movable portion 110 in which the second hydraulic cylinder 40 is incorporated. FIG. 6 is a flowchart illustrating a flow of processing in this case. As illustrated in FIG. 6, the controller 12 monitors whether there is an operation command with respect to the movable portion 110 in which the second hydraulic cylinder 40 is incorporated (S30). As a result, when there is an operation command with respect to the movable portion 110, the controller stands by without performing a position correction. On the other hand, when there is no operation command with respect to the movable portion 110, the controller 12 compares the most recently acquired positional deviation amount DE with the reference deviation amount DEst (S32). As a result of the comparison, when the positional deviation amount DE is less than the reference deviation amount DEst, the controller stands by without performing a position correction. On the other hand, when the positional deviation amount DE is greater than or equal to the reference deviation amount DEst, the controller 12 corrects the positional deviation of the first piston 24 according to the flow of FIG. 5 (S34). Of course, when receiving an operation command with respect to the movable portion 110 during the execution of the position correction, the controller 12 interrupts the position correction processing and drives the hydraulic system 10 according to the operation command.

In addition, any of the configurations described so far is an example. So long as the hydraulic system 10 includes the two connection pipes 80a and 80b that connect the first hydraulic cylinder 20 and the second hydraulic cylinder 40 to each other, the bypass pipe 82 that connects the two connection pipes 80a and 80b to each other, the valve 84 that opens and closes the bypass pipe 82, and the brake 60 that regulates movement of the second piston 44, the other configurations of the hydraulic system 10 may be changed. For example, in the above description, the head-side volume chamber of the first hydraulic cylinder 20 and the head-side volume chamber of the second hydraulic cylinder 40 are connected to each other by the connection pipe 80a. However, the connection combination between the volume chambers may be changed. For example, as illustrated in FIG. 7, the first volume chamber 26 located on the head side of the first hydraulic cylinder 20 may be connected to the third volume chamber 46 located on the rod side of the second hydraulic cylinder 40 by the first connection pipe 80a. In this case, of course, the second volume chamber 28 located on the rod side of the first hydraulic cylinder 20 is connected to the fourth volume chamber 48 located on the head side of the second hydraulic cylinder 40 by the second connection pipe 80b.

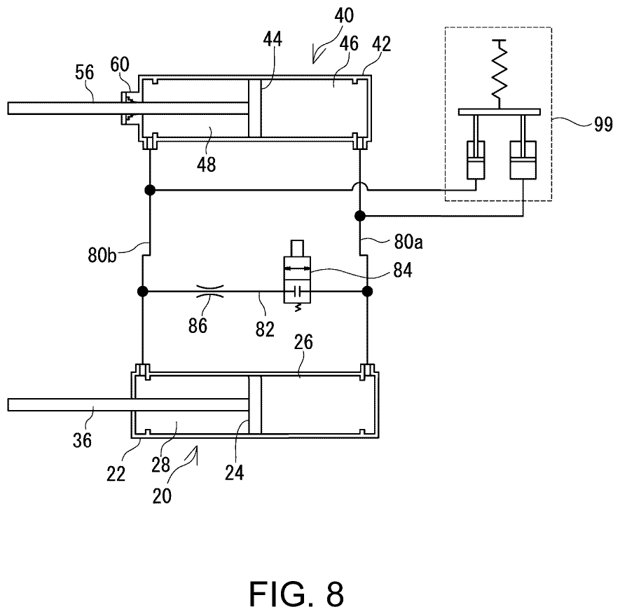

Further, in order to compensate for the reduction of the hydraulic oil due to the external leakage, as illustrated in FIG. 8, an accumulator 99 may be further provided in the hydraulic system 10. In this case, the accumulator 99 is connected to the first connection pipe 80a and the second connection pipe 80b.

### REFERENCE SIGNS LIST

10 Hydraulic system
12 Controller
14 Processor
16 Memory
20 First hydraulic cylinder
22 First cylinder tube
24 First piston
26 First volume chamber
28 Second volume chamber
36 First piston rod
38 First position sensor
40 Second hydraulic cylinder
42 Second cylinder tube
44 Second piston
46 Third volume chamber
48 Fourth volume chamber
56 Second piston rod
58 Second position sensor
60 Brake
62 Fixed body
63 Through hole
64 Movable body
66 Spring
67 Sealed space
68 Hydraulic pressure supply path
70 Brake pump
72 Hydraulic source
74 Tapered surface
76 Wedge portion
80a First connection pipe
80b Second connection pipe
82 Bypass pipe
84 Valve
86 Throttle
90 Linear motion mechanism
92 Servomotor
94 Gear unit
96 Ball screw
98 Moving block
99 Accumulator
100 Host actuator
110 Movable portion
112 Link mechanism

1. A hydraulic system comprising:
a first hydraulic cylinder including a first piston, and a first volume chamber and a second volume chamber whose volumes change as the first piston advances or retreats;
a second hydraulic cylinder including a second piston driven by the first piston, and a third volume chamber and a fourth volume chamber whose volumes change as the second piston advances or retreats;
hydraulic oil filled in the first hydraulic cylinder and the second hydraulic cylinder;
a transmission mechanism including a first connection pipe that allows the first volume chamber and the third volume chamber to communicate with each other and a second connection pipe that allows the second volume chamber and the fourth volume chamber to communicate with each other, the transmission mechanism transmitting a movement of the first piston to the second piston via the hydraulic oil; and
a correction mechanism that corrects a position of the first piston by causing the first piston to advance or retreat in a state where the second piston is stationary;
wherein the correction mechanism includes:
a brake that regulates a movement of the second piston;
a bypass pipe that allows the first connection pipe and the second connection pipe to communicate with each other; and
a valve that opens and closes the bypass pipe.

2. The hydraulic system according to claim 1, further comprising:
a first position sensor that detects a position of the first piston as a first detection position;
a second position sensor that detects a position of the second piston as a second detection position; and
a controller that determines whether it is necessary to correct the position of the first piston based on a comparison between the first detection position and the second detection position.

3. The hydraulic system according to claim 2, wherein
the first position sensor is a contact or non-contact limit switch that outputs a signal when the first piston reaches a prescribed driving-side reference position, and
the controller specifies a positional deviation amount of the first piston based on a second detection position when the first piston reaches the driving-side reference position.

4. The hydraulic system according to claim 2, wherein
the controller corrects the position of the first piston or outputs an alarm at a timing when a positional deviation amount of the first piston exceeds a prescribed reference deviation amount.

5. The hydraulic system according to claim 2, wherein
the controller corrects the position of the first piston or outputs an alarm at a timing when at least one of an operation time, the number of times of operation, and an operation distance of the first hydraulic cylinder or the second hydraulic cylinder exceeds a prescribed reference value.

6. The hydraulic system according to claim 2, wherein
the second hydraulic cylinder is incorporated in a movable portion of a host actuator and
the controller corrects the position of the first piston or outputs an alarm at a timing when an operation command stops with respect to the movable portion.

7. The hydraulic system according to claim 1, wherein
the correction mechanism further includes a throttle provided in the bypass pipe.

8. The hydraulic system according to claim 1, wherein
the first hydraulic cylinder has a larger volume than the second hydraulic cylinder.
